(19) United States
(12) Patent Application Publication
(10) Pub. No.: US 2006/0130106 A1
(43) Pub. Date: Jun. 15, 2006

(54) Network recording system and recording device

(76) Inventors: Yoshiaki Iwata, Moriguchi-shi (JP); Keiji Icho, Matsubara-shi (JP); Kentaro Tanikawa, Kadoma-shi (JP)

Correspondence Address: WENDEROTH, LIND & PONACK L.L.P., 2033 K. STREET, NW, SUITE 800, WASHINGTON, DC, 20006, US

(21) Appl. No.: 10/559,466

(22) PCT Filed: Jun. 7, 2004
(86) PCT No.: PCT/JP04/08262

§ 371 Date: Dec. 5, 2005

(30) Foreign Application Priority Data
Jun. 6, 2003 (JP) 2003-162889

(51) Int. Cl. H04N 7/173; H04N 5/445

(52) U.S. Cl. 725/105; 725/37

(57) ABSTRACT

A network recording system includes a terminal device and a recording device. The terminal device includes a transmitting unit operable to transmit recording instruction information for recording of a punctual program, to the recording device via the network The recording device includes a program receiving unit operable to receive the punctual program, a recording unit operable to start a recording operation of the punctual program from a start time of the punctual program, where the recording operation includes recording the punctual program and performing a process related to the recording, a receiving unit operable to receive the recording instruction information from the terminal device, and a discontinuing unit operable to cause the recording unit to discontinue the recording operation of the punctual program, if the receiving unit does not receive the recording instruction information before a predetermined time elapses from the start time of the punctual program.

### TECHNICAL FIELD

The present invention relates to a recording device that records a punctual program, in place of a terminal device, based on a recording instruction received from the terminal device via a network.

### BACKGROUND ART

Nowadays, various types of video distribution services using a network such as the Internet and a Local Area Network (LAN) are provided. One of such services is a program recording service.

The program recording service is explained in the following part. A recording center receives, via a network, information relating to an instruction to record a program (hereinafter referred to as “recording instruction information”) from a terminal device (e.g. a mobile telephone) owned by a user of the service. A recording device included in the recording center then performs a recording operation of the program in place of the terminal device. The recording device transmits data of the recorded program to the terminal device via the network, upon receiving a playback request from the terminal device.

In this program recording service, the recording center needs to have received recording instruction information for a television program from the terminal device before a start time of the television program, in order to reliably record the entire television program from the beginning to end. Here, the television program is a punctual program, that is, a program which starts at a fixed time.

If a network failure (e.g. interruption and delay) occurs, however, the recording instruction information may not reach the recording center by the start time of the television program. If such is the case, the recording device can not perform a recording operation of the television program from the start time of the television program.

Also, if the user desires to record a television program but the television program has already started, the user may give up using the program recording service as he can not obtain the entire television program.

This means a provider of the program recording service loses a customer to provide its service with. This creates a strong demand of the service provider for a program recording service which does not cause the above-mentioned problem.

To solve the problem, the recording device may perform a recording operation of all received programs from the start time of the programs, in other words, perform constant recording.

In the case of constant recording, however, even programs which are not requested by the user are recorded. That is to say, the hardware resources of the recording device are wasted, and therefore large power consumption is required.

A recording operation performed by the recording device includes, in addition to recording a punctual program, processes such as converting the format of data of the recorded program into a format that is compatible with the terminal device, and generating data relating to the recorded program. If the recording device performs constant recording, the recording device performs the above conversion and generation processes for the programs the user does not request. Accordingly, the hardware resources of the recording device are wasted.

### DISCLOSURE OF THE INVENTION

It is an object of the present invention to provide a network recording system, a recording device, and techniques relating to the recording device, which have the following improvements. A punctual program can be recorded from the start time of the program, even when a recording device receives recording instruction information for the program later than the start time of the program due to a network failure or user's circumstances. In addition, the waste of the hardware resources and the power consumption of the recording device can be minimized, when compared with the above-mentioned constant recording.

The object can be achieved by a network recording system including a terminal device and a recording device which are connected to a network. The terminal device comprises a transmitting unit operable to transmit recording instruction information for recording of a punctual program, to the recording device via the network. The recording device comprises a program receiving unit operable to receive the punctual program, a recording unit operable to start a recording operation of the punctual program from a start time of the punctual program, where the recording operation includes recording the punctual program and performing a process related to the recording, a receiving unit operable to receive the recording instruction information from the terminal device, and a discontinuing unit operable to cause the recording unit to discontinue the recording operation of the punctual program, if the receiving unit does not receive the recording instruction information before a predetermined time elapses from the start time of the punctual program.

The object can be achieved by a recording device comprising a receiving unit operable to receive recording instruction information for a punctual program via a network from an external device, a program receiving unit operable to receive the punctual program, a recording unit operable to start a recording operation of the punctual program from a start time of the punctual program, where the recording operation includes recording the punctual program and performing a process related to the recording, and a discontinuing unit operable to cause the recording unit to discontinue the recording operation of the punctual program, if the receiving unit does not receive the recording instruction information before a predetermined time elapses from the start time of the punctual program.

The recording device may further comprise a transmitting unit operable to transmit recording instruction information to another recording device via the network, to instruct the other recording device to record a punctual program.

The object can be achieved by a recording method comprising steps of receiving a punctual program, starting a recording operation of the punctual program from a start time of the punctual program, where the recording operation includes recording the punctual program and performing a process related to the recording, receiving recording instruction information for the punctual program via a network from an external device, and discontinuing the recording operation of the punctual program, if the recording instruction information is not received in the receiving step before a predetermined time elapses from the start time of the punctual program.

The object can be achieved by a computer-readable control program to cause a recording device to perform a recording control, where the recording device includes a processor, a reception tuner, and a network communication unit. The computer-readable control program comprises steps of starting a recording operation of a punctual program that is received by the reception tuner from a start time of the punctual program, where the recording operation includes recording the punctual program and performing a process related to the recording, and discontinuing the recording operation of the punctual program, if the network communication unit does not receive recording instruction information for the punctual program, via a network, from an external device before a predetermined time elapses from the start time of the punctual program.

The object can be achieved by a storage medium storing a computer-readable control program to cause a recording device to perform a recording control, where the recording device includes a processor, a reception tuner, and a network communication unit. The computer-readable control program comprises steps of starting a recording operation of a punctual program that is received by the reception tuner from a start time of the punctual program, where the recording operation includes recording the punctual program and performing a process related to the recording, and discontinuing the recording operation of the punctual program, if the network communication unit does not receive recording instruction information for the punctual program, via a network, from an external device before a predetermined time elapses from the start time of the punctual program.

The object can be achieved by an integrated circuit for use in a recording device including a receiving unit operable to receive recording instruction information for a punctual program from an external device via a network and a program receiving unit operable to receive the punctual program. The integrated circuit comprises a recording unit operable to start a recording operation of the punctual program from a start time of the punctual program, where the recording operation includes recording the punctual program and performing a process related to the recording, and a discontinuing unit operable to cause the recording unit to discontinue the recording operation of the punctual program, if the receiving unit does not receive the recording instruction information for the punctual program before a predetermined time elapses from the start time of the punctual program.

Here, the punctual program is a program a start time of which can be specified so as that the program can be recorded from the start. Recording a program indicates recording image data, and also implies recording video and audio, as more generally recognized. The process related to the recording is, for example, a process to convert the format of data and a process to generate related data for the recorded program.

According to the above-mentioned construction, even when the recording instruction information is received at a time later than the start time of the punctual program, the punctual program can be recorded from the start and the user can obtain the entire program. Furthermore, if a recording instruction for the punctual program is not received before the predetermined time elapses from the start time of the punctual program, the recording operation of the program is discontinued. As a result, the waste of the hardware resources and the power consumption of a recording device can be reduced, when compared with the constant recording.

Here, the transmitting unit may measure a transmission time at which the transmitting unit transmits the recording instruction information, have transmission time information indicating the transmission time included in the recording instruction information, and transmit the recording instruction information to the recording device. In addition, the recording device may further comprise a calculating unit operable to measure a reception time at which the receiving unit receives the recording instruction information, and calculate a time difference between the transmission time indicated by the transmission time information and the reception time, and a setting unit operable to set the predetermined time based on the calculated time difference.

According to this construction, a delay absorption time can be provided to deal with a network delay. Therefore, the waste of the hardware resources and the power consumption of the recording device can be reduced.

Here, the terminal device may further comprise a reception unit operable to receive setting of the predetermined time, and a setting transmission unit operable to transmit setting information relating to the received setting to the recording device, and the recording device may further comprise a setting unit operable to set the predetermined time based on the setting information transmitted from the terminal device.

According to this construction, a user can arbitrarily set the delay absorption time.

### BRIEF DESCRIPTION OF THE DRAWINGS

FIG. 1 illustrates an example construction of a network recording system relating to an embodiment of the present invention.

FIG. 2 illustrates, as an example, program guide information.

FIG. 3 illustrates a concrete example of a channel table.

FIG. 4 illustrates an example of a Graphical User Interface (GUI) screen displayed on a display unit of a terminal device.

FIG. 5 illustrates a data construction of instruction information transmitted from the terminal device to a recording device.

FIG. 6 illustrates a concrete example of a recording instruction management table.

FIG. 7 is a flow chart illustrating a recording control operation.

FIG. 8 illustrates a recording instruction reception time, a delay absorption time, and a time chart of a program.

FIG. 9 illustrates a recording instruction reception time, a delay absorption time, and a time chart of a program.

FIG. 10 illustrates an example construction of a network recording system relating to a modification example of the present invention.

FIG. 11 illustrates an example construction of a network recording system relating to another modification example of the present invention.

### BEST MODE FOR CARRYING OUT THE INVENTION

The following part describes a network recording system which is an embodiment of the present invention, with reference to the attached figures.

### 1. CONSTRUCTION OF THE NETWORK RECORDING SYSTEM 1

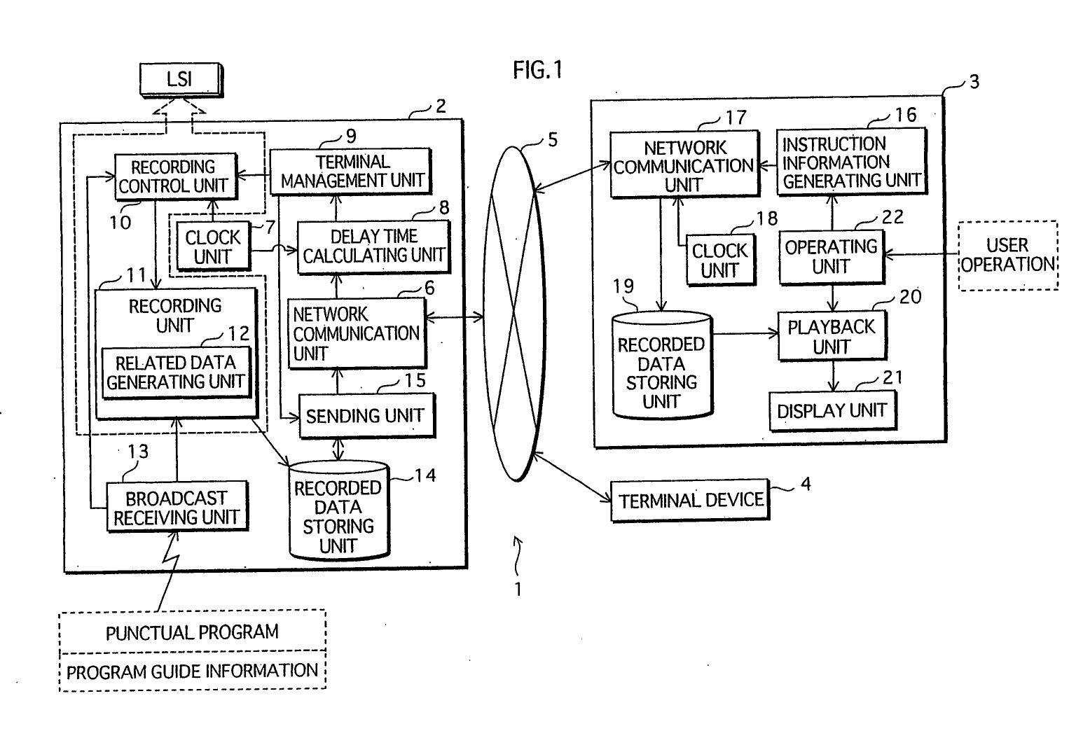

FIG. 1 illustrates a construction of a network recording system 1.

The network recording system 1 includes a recording device 2, a terminal device 3, a terminal device 4, a network 5 and the like. The number of terminal devices in the network recording system 1 is not limited to two, and may be several thousand to several ten thousand. Likewise, the number of recording devices is not limited to one either, and may be several thousand to several ten thousand.

The network 5 is, as an example, a LAN or the Internet. Each of the recording device 2, and the terminal devices 3 and 4 is a computer including hardware such as a CPU, an input/output device (e.g. a reception tuner, a communication modem, a User Interface (UI) circuit), a memory and a hard disk.

The terminal devices 3 and 4 each receive a recording instruction for a program from a user, and transmits recording instruction information to the recording device 2 via the network 5.

The recording device 2 performs a recording control described in the following. The recording device 2 starts a recording operation for each broadcasted program from a start time of the program, based on program guide information obtained via a broadcast wave or the network 5. The recording device 2 discontinues the recording operation, if the recording device 2 does not receive recording instruction information that instructs the recording device 2 to record the program from any of the terminal devices 3 and 4 before a predetermined delay absorption time elapses from the start time of the recording operation. The recording device 2 continues the recording operation of the program, if the recording device 2 receives recording instruction information that instructs the recording device 2 to record the program from either of the terminals devices 3 and 4 before the predetermined delay absorption time elapses from the start time of the recording operation.

The following part describes functional units of each of the terminal device 3 and the recording device 2. Note here that functional units that are not particularly important for the present invention are not explained.

### 1.1 Construction of the Terminal Device 3

The terminal device 3 includes an instruction information generating unit 16, a network communication unit 17, a clock unit 18, a recorded data storing unit 19, a playback unit 20, a display unit 21, and an operating unit 22. The functional units of the terminal device 3 are realized in such a manner that a CPU executes a terminal device control program stored in a memory.

The terminal device 4 has the same functional units as the terminal device 3, and therefore not explained here.

The operating unit 22 has a function of receiving various kinds of user instructions through the user's button operations or the like. For example, the terminal device 3 displays a program recording selection screen on the display unit 21, so as to receive a recording instruction through the user's operations of a pointing device.

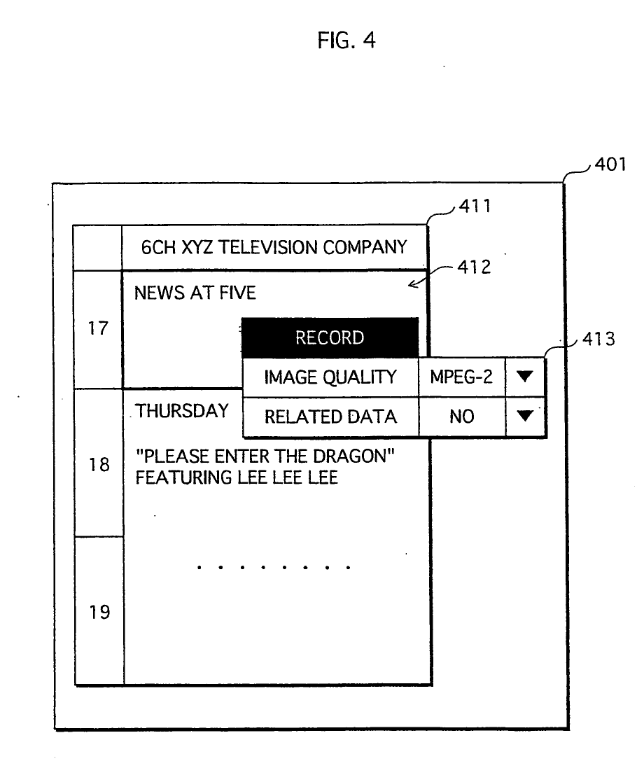

FIG. 4 illustrates an example of a GUI screen displayed on the display unit 21 in the terminal device 3. FIG. 4 shows a screen 401, which is a program guide for a time period from 17:00 to 19:00, XYZ Television Company, and Channel 6 in the Osaka region.

Generally speaking, a GUI is realized by arranging, for example, icons and buttons on a display screen. The icons and buttons are displayed, for example, as a letter or a picture and each have a specific property. Personal computers and various kinds of audio-video devices, for example, receive operations from users and present information to the users through GUIs.

A program guide 411 is generated based on program guide information and a channel table (mentioned later), and displayed on the screen 401. When a program content section 412 is selected with a cursor, a recording instruction window 413 appears.

The recording instruction window 413 has three GUI buttons, which are a recording instruction button “RECORD”, an image quality selecting button, and a related data selecting button. The user can designate the image quality of program data to be recorded, by selecting one of a plurality of image quality options displayed when the image quality selecting button is pressed.

Also, the user can select whether related data should be generated regarding the program data to be recorded by selecting one of YES and NO options displayed when the related data selecting button is pressed.

Furthermore, the user can issue a recording instruction for the program to the terminal device 3, by pressing the recording instruction button.

The operating unit 22 receives various kinds of instructions from the user. If a received instruction is a recording or playback instruction, the operating unit 22 sends the instruction to the instruction information generating unit 16.

The instruction information generating unit 16 has a function of generating recording instruction information and playback instruction information, based on recording and playback instructions from the user. The instruction information generating unit 16 sends generated instruction information to the network communication unit 17.

The clock unit 18 has a function of indicating current date and time. The clock unit 18 notifies the network communication unit 17 of the current date and time.

The network communication unit 17 has a function of communicating with other devices connected to the network 5. The network communication unit 17 appends time information indicating the date and time notified by the clock unit 18 to information to transmit. The network communication unit 17 is realized by hardware, such as a LAN card or a modem.

The recorded data storing unit 19 is a memory area for storing recorded program data received from the recording device 2 via the network 5. The recorded data storing unit 19 may use one of a download method and a streaming method to receive recorded data.

The playback unit 20 has a function of reading recorded data stored in the recorded data storing unit 19, and playing the recorded data back. When the recorded data is played back, audio and video of the recorded data are output from the display unit 21.

### 1.2 Construction of the Recording Device 2

The following part describes functional units of the recording device 2.

The recording device 2 includes a network communication unit 6, a clock unit 7, a delay time calculating unit 8, a terminal management unit 9, a recording control unit 10, a recording unit 11, a broadcast receiving unit 13, a recorded data storing unit 14, and a sending unit 15. The recording unit 11 includes a related data generating unit 12. The functional units are realized in such a manner that a CPU executes a recording device control program stored in a memory.

As shown in FIG. 1, the recording control unit 10 and the recording unit 11 are formed as an integrated circuit.

The network communication unit 6 has a function of communicating with other devices connected to the network 5. The network communication unit 6 sends recording instruction information and playback instruction information received from the terminal device 3 or 4, to the delay time calculating unit 8.

The clock unit 7 has a function of indicating current date and time. The clock unit 7 notifies the delay time calculating unit 8 and the recording control unit 10 of the current date and time.

The delay time calculating unit 8 has a function of calculating a delay time. The delay time is a time difference between (i) a transmission time indicated by transmission time information appended to recording instruction information or playback instruction information that is received from the network communication unit 6 and (ii) the current time notified by the clock unit 7. The delay time calculating unit 8 sends the delay time obtained by such a calculation to the terminal management unit 9 together with the recording instruction information or playback instruction information.

The terminal management unit 9 has a function of managing each piece of recording instruction information or playback instruction information transmitted from the terminal device 3 or 4. Also, the terminal management unit 9 has a function of setting an optimal delay absorption time based on a delay time received from the delay time calculating unit 8.

The optimal delay absorption time is a maximum value out of delay times of the terminal devices 3 and 4. For example, when the delay times of the terminal devices 3 and 4 calculated by the delay time calculating unit 8 are respectively two seconds, and three seconds, the optimal delay absorption time is set to three seconds.

The terminal management unit 9 notifies the recording control unit 10 of the delay absorption time and recording instruction information transmitted from the terminal device 3 or 4, and transmits playback instruction information to the sending unit 15.

The broadcast receiving unit 13 has a function of receiving digital broadcasts and demodulating broadcast waves. The digital broadcasts referred to here use the MPEG-2-Transport Stream (TS) method, which is defined by ISO/IEC 13818. A TS includes program guide information and the like in addition to program data.

The program guide information is constituted by a plurality of pieces of table information, which include Program Specific Information (PSI) and Service Information (SI). PSI and SI are each defined by the MPEG-2 standard.

A TS is formed by TS packets, which each have a payload and a header. The header stores identifying information to identify the contents of the payload. The broadcast receiving unit 13 separates and extracts particular data based on this identifying information. The program guide information is extracted and sent to the recording control unit 10. The program data is extracted and sent to the recording unit 11.

The recording control unit 10 has a function of causing the recording unit 11 to start and discontinue a recording operation of a program. The recording control unit 10 controls the recording unit 11 so as that the recording unit 11 starts the recording operation of the program at a start time of the program, based on the program guide information received from the broadcast receiving unit 13. Here, the clock unit 7 notifies the recording control unit 10 of the current time. When the recording control unit 10 does not receive recording instruction information for the program from the terminal management unit 9 before the predetermined delay absorption time elapses from the start time of the program, the recording control unit 10 controls the recording unit 11 so as that the recording unit 11 discontinues the recording operation of the program.

The recording unit 11 has a function of performing a recording operation of program data received from the broadcast receiving unit 13, under control of the recording control unit 10. The recording operation performed by the recording unit 11 includes not only recording of broadcasted data in its original format, but also converting the format of the recorded data into a format desired by a user. For example, the recording unit 11 converts program data in the MPEG-2 format into program data in the MPEG-4 format.

The recording unit 11 includes the related data generating unit 12. The related data generating unit 12 generates related data in accordance with an instruction to generate related data which is included in recording instruction information. The related data includes section detecting information and caption information. The recorded program data and generated related data are stored in the recorded data storing unit 14.

The recorded data storing unit 14 is a large-capacity storage medium.

The sending unit 15 has a function of reading corresponding program data from the recorded data storing unit 14 in response to playback instruction information sent from the terminal management unit 9, and transmitting the read program data to a terminal device which has issued the playback instruction, using a protocol such as the HyperText Transfer Protocol (HTTP) or the File Transfer Protocol (FTP). If the program data specified by the playback instruction information is not found in the recorded data storing unit 14, the sending unit 15 transmits error information to the terminal device which has transmitted the playback instruction information.

### 2. DATA

The following part describes various kinds of data.

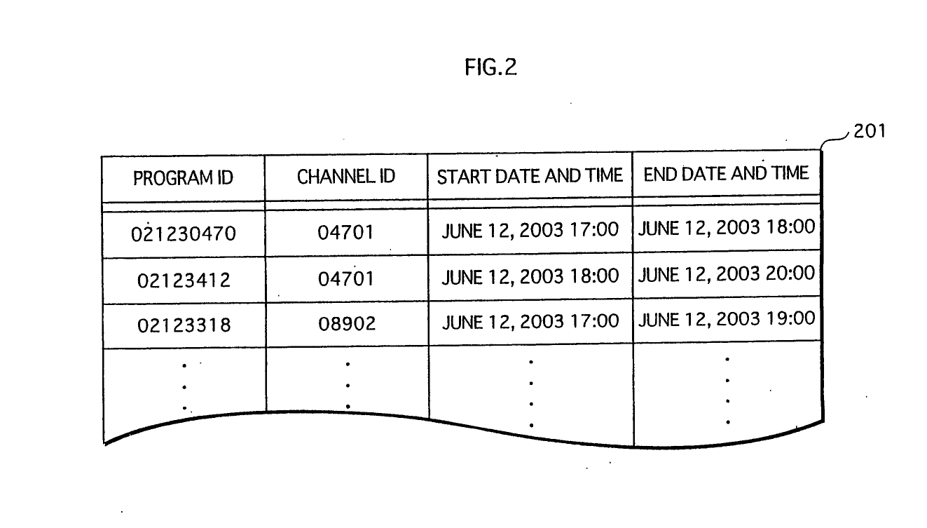

FIG. 2 illustrates a concrete example of program guide information. Program guide information 201 is made up of item information, which includes a program ID of a program, a channel ID, start date and time of the program, and end date and time of the program.

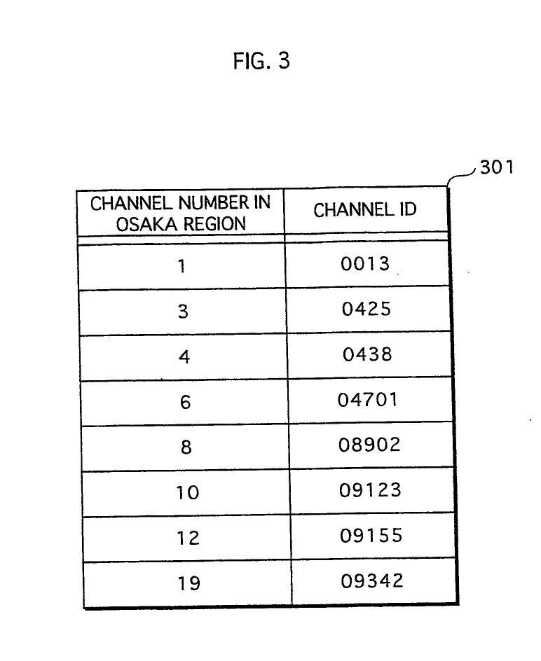

FIG. 3 illustrates a concrete example of a channel table, which shows a one-to-one correspondence between channel numbers that represent television companies in the Osaka region and channel IDs.

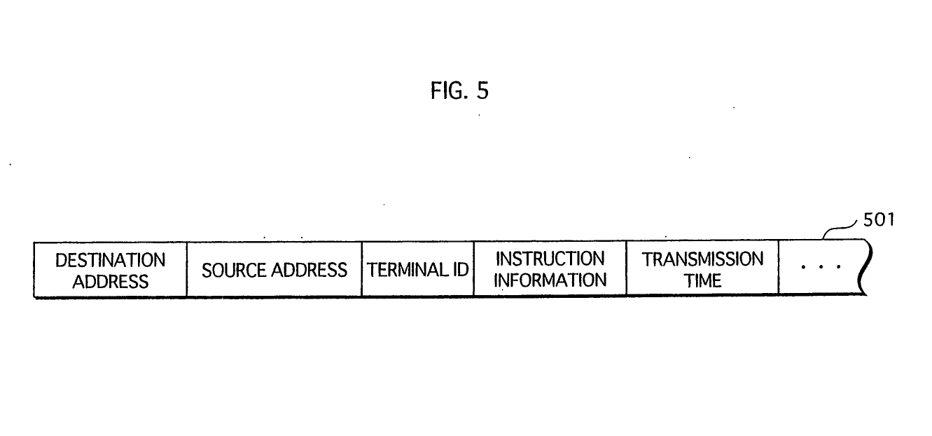

FIG. 5 illustrates a data construction of instruction information 501 transmitted from the terminal device 3 to the recording device 2.

In the drawing, the instruction information 501 includes a destination address, a source address, a terminal ID, instruction information, a transmission time and the like.

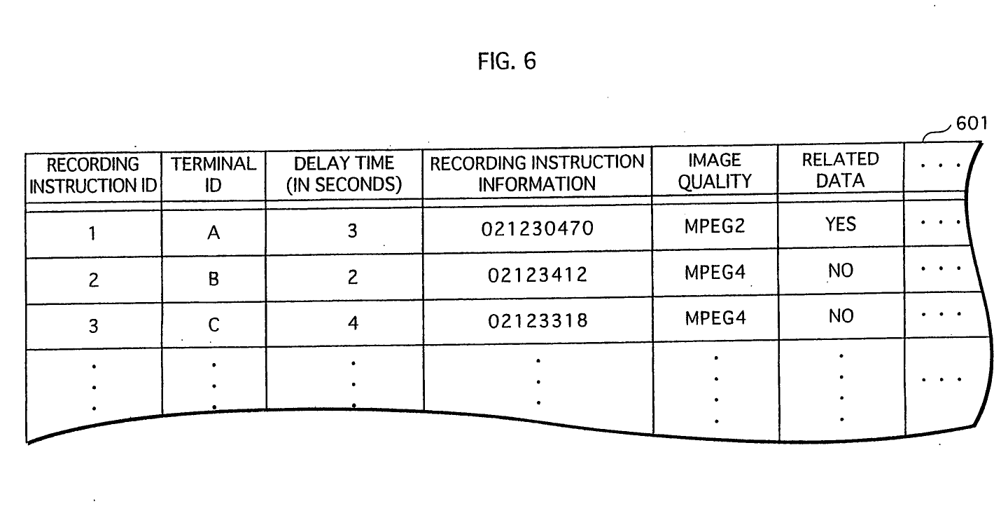

FIG. 6 illustrates a concrete example of a recording instruction management table managed by the terminal management unit 9. A recording instruction management table 601 is made up of item information, which includes a recording instruction ID, a terminal ID, a delay time, recording instruction information, an image quality, related data and the like. The terminal management unit 9 assigns a recording instruction ID to each piece of recording instruction information transmitted from the terminal devices 3 and 4, to manage a plurality of pieces of recording instruction information.

### 3. OPERATION

The following part describes a recording control operation performed by the recording control unit 10 in the recording device 2.

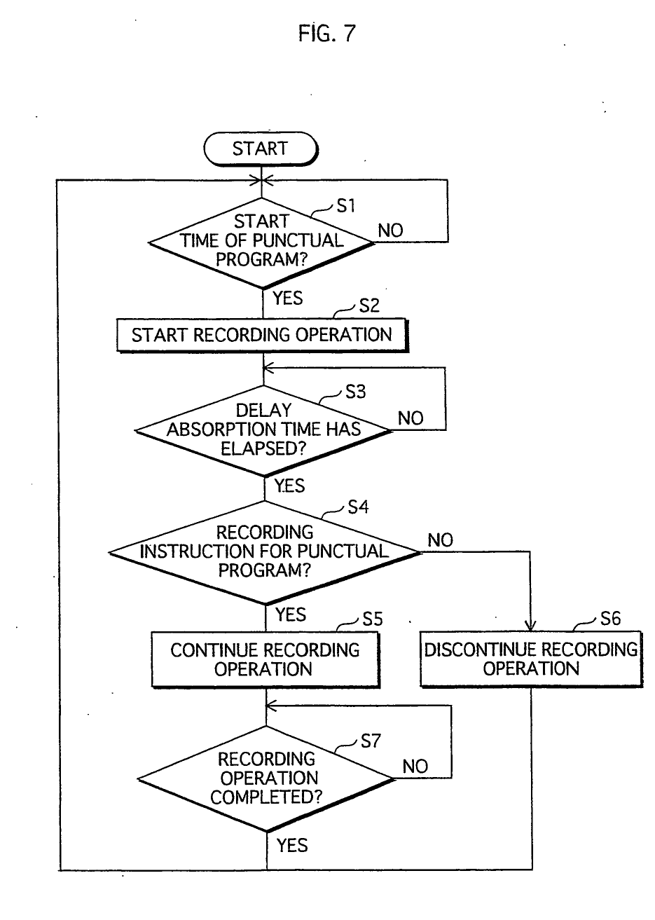

FIG. 7 is a flow chart illustrating the recording control operation.

The recording control unit 10 judges whether the current time is a start time of a punctual program, based on the program guide information and the current time notified by the clock unit 7 (step S1). If the current time is the start time of the punctual program (step S1:YES), the recording control unit 10 causes the recording unit 11 to start a recording operation of the punctual program (step S2). After this, when the delay absorption time set by the terminal management unit 9 has elapsed from the start time of the punctual program (step S3:YES), the recording control unit 10 judges whether a recording instruction for the punctual program has been received before the delay absorption time elapses (step S4).

If the recording instruction for the punctual program has been received (step S4:YES), the recording control unit 10 causes the recording unit 11 to continue the recording operation of the punctual program (step S5). Then, once the recording unit 11 has completed the recording operation of the punctual program (step S7:YES), the procedure of the recording control operation goes back to the step S1.

If the recording instruction for the punctual program has not been received (step S4:NO), the recording control unit 10 causes the recording unit 11 to discontinue the recording operation of the punctual program (step S6). Here, data recorded until the recording operation is discontinued may be discarded. After this, the procedure of the recording control operation goes back to the step S1.

### 3.1. Concrete Example of Operation

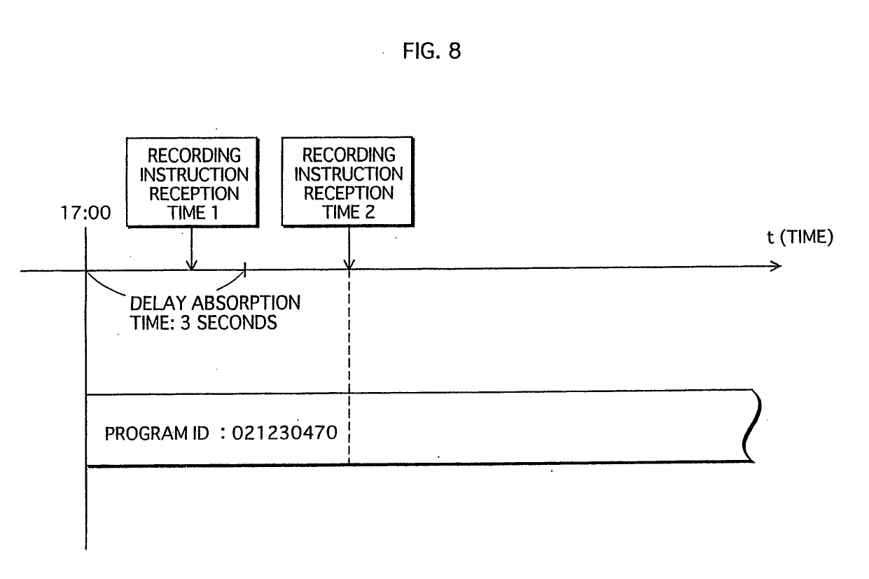

The following part describes a specific example of the recording control operation with reference to FIG. 8.

FIG. 8 illustrates a reception time at which recording instruction information is received and a time chart of a program 1 which has a program ID of 021230470. The program 1 is a punctual program starting at 17:00. The recording control unit 10 causes the recording unit 11 to start a recording operation of the program 1 from 17:00.

Here, it is assumed that the delay absorption time set by the terminal management unit 9 is three seconds as shown in FIG. 8. If a recording instruction is received at a recording instruction reception time 1, that is to say, within three seconds from the start time of the program 1, the recording control unit 10 causes the recording unit 11 to continue the recording operation of the program 1 after the delay absorption time elapses.

However, if the recording instruction is received at a recording instruction reception time 2, that is to say, after the delay absorption time of three seconds has elapsed, the recording control unit 10 causes the recording unit 11 to restart the recording operation of the program 1 from the recording instruction reception time 2.

### 4. OTHER MODIFICATION EXAMPLES

The present invention is not limited to the above-mentioned embodiment, and includes the following modifications.

### 4.1. First Modification Example

According to the above-mentioned embodiment, the terminal management unit 9 sets the delay absorption time based on a network delay time. However, the delay absorption time may be set by a service provider or a user.

In FIG. 8, for example, if a recording instruction is received from a user at the recording instruction reception time 2, the user can not record the program 1 from the start due to a slight delay. However, if the delay absorption time is set to 30 minutes, the above-mentioned problem can be solved.

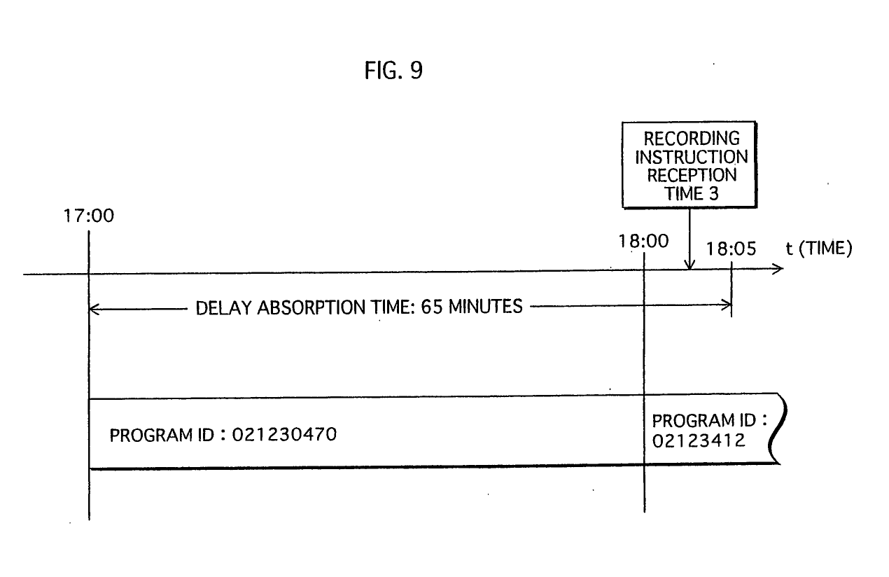

Also, the delay absorption time may be longer than a duration of the program 1 by a specific time period as shown in FIG. 9.

FIG. 9 illustrates a time chart of the program 1 having the program ID of 021230470. In FIG. 9, the delay absorption time is set to 65 minutes by a service provider or a user.

The program 1 is a 60-minute program from 17:00 to 18:00. Accordingly, the recording control unit 10 causes the recording unit 11 to continue a recording operation of the program 1 until five minutes has passed after the end time of the program 1.

The following part describes how the recording operation is performed after the end time of the program 1. The recording operation includes, for example, a process of converting the format of program data (e.g. from MPEG2 to MPEG4) and a process of generating related data. Therefore, the recording operation of the program 1 may not automatically end at 18:00 when the program 1 ends.

It is assumed that the recording operation of the 60-minute program 1 takes 70 minutes and the delay absorption time is set at 65 minutes. If the recording instruction for the program 1 is not received before the delay absorption time has elapsed, the recording unit 11 does not perform the recording operation to be performed during five minutes from 18:05 to 18:10. As a result, the waste of the hardware resources and the power consumption can be reduced.

### 4.2. Second Modification Example

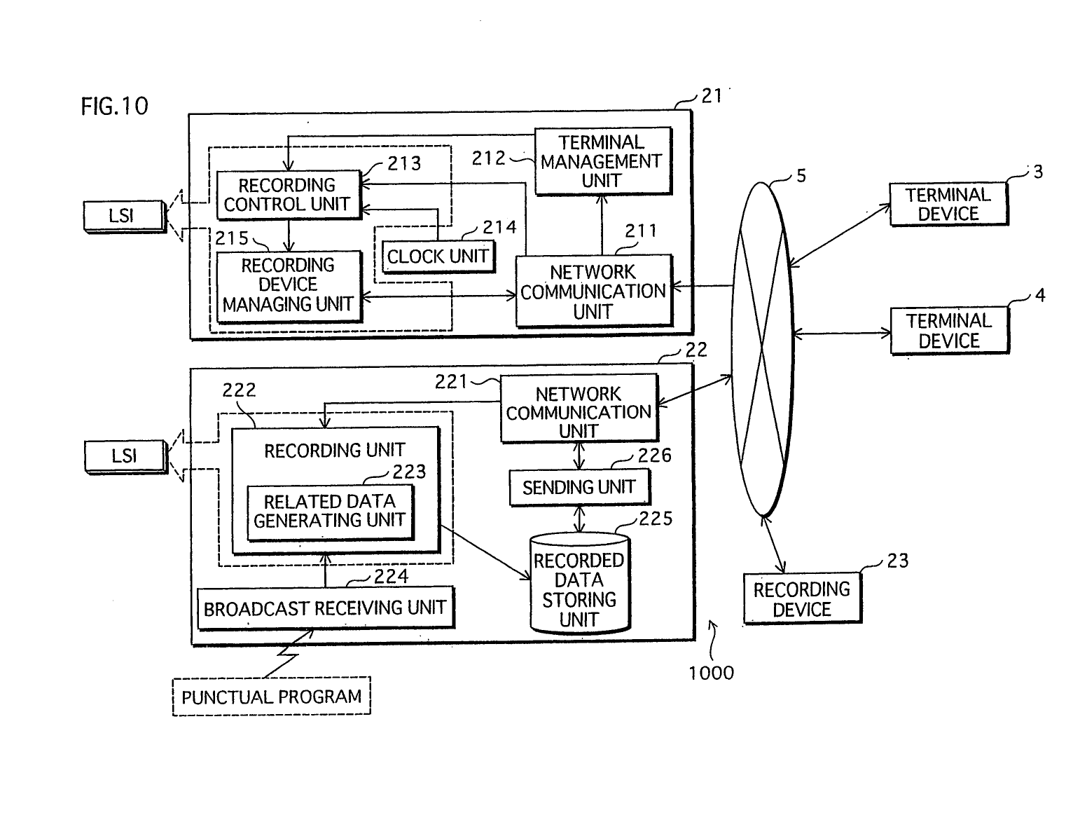

A second modification example of the present invention may be a network recording system having a construction shown in FIG. 10.

A network recording system 1000 includes the terminal device 3, the terminal device 4, the network 5, a management server 21, a recording device 22, and a recording device 23. The number of terminal devices or recording devices in the network recording system 1000 is not limited to two as shown in FIG. 10, but may be several thousand or several ten thousand.

The management server 21 has a function of receiving recording instruction information and playback instruction information from the terminal devices 3 and 4, and a function of managing the recording devices 22 and 23 connected to the network 5.

As shown in FIG. 10, a recording control unit 213 and a recording device managing unit 215 in the management server 21 are formed as an integrated circuit.

A network communication unit 211 and a clock unit 214 have the same functions as the network communication unit 6 and the clock unit 7 in the recording device 2 described in the above-mentioned embodiment.

A terminal management unit 212 has a function of managing recording instruction information, playback instruction information and a delay absorption time notified by the terminal devices 3 and 4. Here, the delay absorption time is set by a service provider.

The recording control unit 213 retrieves program guide information from a device of a broadcast station via the network 5. Also, the recording control unit 213 generates recording start instruction information to instruct starting a recording operation of a program, based on the program guide information, and sends the recording start instruction information to the recording device managing unit 215.

If a recording instruction for the program is not received before the delay absorption time elapses from the start time of the program, the recording control unit 213 sends recording stop instruction information to discontinue the recording operation of the program, to the recording device managing unit 215. The recording start instruction information and the recording stop instruction information each include a channel ID, a program ID, instruction information to start or discontinue the recording operation, the start time of the program, an end time of the program, and the like.

The recording device managing unit 215 has a function of instructing each of the recording devices 22 and 23 connected to the network 5 to start or discontinue a recording operation. Here, the recording devices 22 and 23 managed by the recording device managing unit 215 correspond to different broadcast channels. For example, the recording device 22 records programs on a channel with a channel ID of 0013, and the recording device 23 records programs on a channel with a channel ID of 0425.

When receiving the recording start instruction information from the recording control unit 213, the recording device managing unit 215 refers to the channel ID in the recording start instruction information, and transmits the recordings tart instruction information to a recording device corresponding to a channel indicated by the channel ID.

When receiving the recording stop instruction information from the recording control unit 213, the recording device managing unit 215 refers to the channel ID in the recording stop instruction information, and transmits the recording stop instruction information to the recording device corresponding to the channel indicated by the channel ID.

The recording devices 22 and 23 have the same functions. IS Therefore, the following part describes the recording device 22 only.

The recording device 22 includes a network communication unit 221, a recording unit 222, a broadcast receiving unit 224, a recorded data storing unit 225, and a sending unit 226. The recording unit 222 includes a related data generating unit 223. These functional units are respectively the same as the network communication unit 6, the recording unit 11, the broadcast receiving unit 13, the recorded data storing unit 14, the sending unit 15 and the related data generating unit 12 included in the recording device 2 described in the above-mentioned embodiment.

As shown in FIG. 10, the recording unit 222 is formed as an integrated circuit.

The recording device 22 performs a recording operation based on the recording start instruction information and the recording stop instruction information transmitted from the management server 21. When receiving the recording start instruction information, the recording device 22 starts a recording operation. When receiving the recording stop instruction information, the recording device 22 discontinues the recording operation.

### 4.3. Third Modification Example

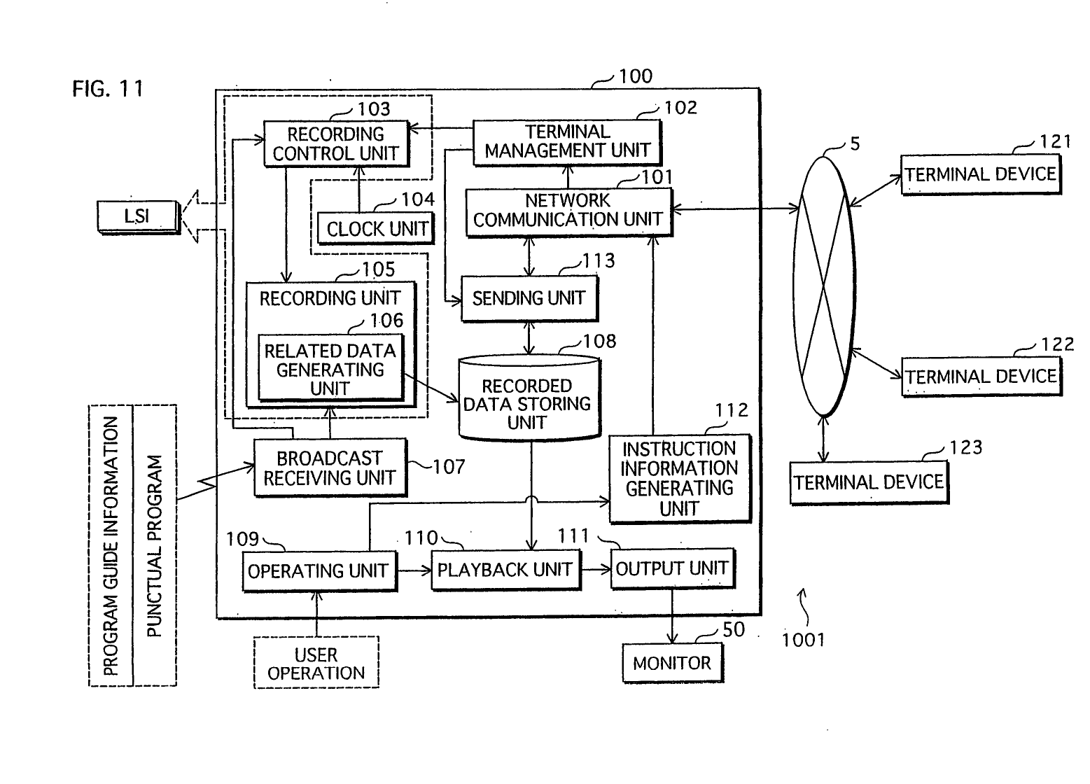

Another modification example of the present invention may be a network recording system having a construction shown in FIG. 11.

A network recording system 1001 includes a plurality of terminal devices 100, 121, 122, and 123 each of which has a recording function. The terminal devices 100, 121, 122, and 123 are, for example, digital video recorders that can be connected to a network.

The terminal devices 100, 121, 122, and 123 shown in FIG. 11 receives a broadcast of a punctual program, so as to play back or record the program. Also, the terminal devices 100, 121, 122 and 123 requests each another to record a program.

The terminal devices 100, 121, 122, and 123 all have the same functions. Therefore, the following part describes the terminal device 100 only.

The terminal device 100 includes a network communication unit 101, a terminal management unit 102, a recording control unit 103, a clock unit 104, a recording unit 105, a broadcast receiving unit 107, a recorded data storing unit 108, an operating unit 109, a playback unit 110, an instruction information generating unit 112, and a sending unit 113. The recording unit 105 includes a related data generating unit 106. These functional units are the same as the network communication unit 17, the terminal management unit 9, the recording control unit 10, the clock unit 18, the recording unit 11, the broadcast receiving unit 13, the recorded data storing unit 19, the operating unit 22, the playback unit 20, the instruction information generating unit 16, the sending unit 15 and the related data generating unit 12 in the terminal device 3 and the recording device 2 described in the above embodiment.

As shown in FIG. 11, the recording control unit 103, the recording unit 105 are formed as an integrated circuit.

The operating unit 109 in the terminal device 100 receives a recording instruction from a user. Also, the network communication unit 101 receives recording instruction information from any of the terminal devices 121, 122 and 123.

Here, the delay absorption time is set by a user who owns the terminal device 100.

The recording control unit 103 causes the recording unit 105 to start a recording operation of a program based on program guide information from a start time of the program. If the recording control unit 103 does not receive a recording instruction for the program from a user, or recording instruction information for the program from any of the terminal devices 121, 122 and 123, before the predetermined delay absorption time has elapsed from the start time of the program, the recording control unit 103 causes the recording unit 105 to discontinue the recording operation of the program.

### 5. OTHER MODIFICATIONS

(1) The contents of the related data described in the above-mentioned embodiment may be determined based on a selection from three or more options, which include, for example, “detailed”, “brief”, and “not generated”.

(2) In the above embodiment, the network recording system records digital broadcasts. However, the network recording system may record broadband broadcasts on the Internet.

(3) The present invention may include a recording method including the recording control operation illustrated in FIG. 7 and performed by the recording control unit 10 described in the above-mentioned embodiment, and a computer-readable control 10 program to cause the recording device 2 to execute the recording control operation. Such a computer-readable control program can be distributed in a state of being stored in storage media or via various kinds of communication paths. Such storage media include IC cards, optical disks, flexible disks, and memories.

A distributed computer-readable control program may be installed in, for example, a device with a storing unit, so as to be used. The device realizes the functions described in the embodiment, by executing the computer-readable control program.

(4) The above embodiment mentions that the recording control unit 10 and the recording unit 11 are formed as an integrated circuit. The same holds true for the recording control unit 103 and the recording unit 105, the recording control unit 213 and the recording device managing unit 215, and the recording unit 222. As an alternative, each of these functional units may be formed as a one-chip integrated circuit. As another alternative, a one-chip integrated circuit including the clock unit 7, the delay time calculating unit 8, and the terminal management unit 9 shown in FIG. 1 in addition to the recording control unit 10 and the recording unit 11 may be employed for the recording device 2, and a one-chip integrated circuit including the network communication unit 6 and the sending unit 15 shown in FIG. 1 in addition to the above-mentioned functional units may be employed.

The integrated circuits may be LSIs depending on the integration degree of the devices.

A special-purpose circuit, a general processor, a Field Programmable Gate Array (FPGA), or Reconfigureable Processor may be used for the integrated circuits. The FPGA and Reconfigurable Processor can change the architecture. In addition, if advance in technology enables a replacement for a semiconductor integrated circuit to be developed, for example, an integrated circuit using a biotechnology, the new type of integrated circuit can be used for the integrated circuits as well.

### 6. EFFECTS OF THE INVENTION

As clearly mentioned in the above description, the construction of the network recording system relating to the embodiment of the present invention achieves the following improvement. Even though recording instruction information for a punctual program is received from a user after a start time of the program, the program can be recorded from the start, so that the user can obtain the entire program. If the recording instruction for the program is not received before a predetermined time elapses from the start time of the program, a recording operation of the program which includes recording of the program and related processes is discontinued. As a result, the waste of the hardware resources and the power consumption of the recording device can be reduced, when compared with the constant recording.

### INDUSTRIAL APPLICABILITY

The present invention can be employed for a network recording system to provide a program recording service.

1. A network recording system including a terminal device and a recording device which are connected to a network, the terminal device comprising:
a transmitting unit operable to transmit recording instruction information for recording of a punctual program, to the recording device via the network, and
the recording device comprising:
a program receiving unit operable to receive the punctual program;
a recording unit operable to start a recording operation of the punctual program from a start time of the punctual program, the recording operation including recording the punctual program and performing a process related to the recording;
a receiving unit operable to receive the recording instruction information from the terminal device; and
a discontinuing unit operable to cause the recording unit to discontinue the recording operation of the punctual program, if the receiving unit does not receive the recording instruction information before a predetermined time elapses from the start time of the punctual program.

2. The network recording system of claim 1, wherein
the transmitting unit measures a transmission time at which the transmitting unit transmits the recording instruction information, has transmission time information indicating the transmission time included in the recording instruction information, and transmits the recording instruction information to the recording device, and
the recording device further comprises:
a calculating unit operable to measure a reception time at which the receiving unit receives the recording instruction information, and calculate a time difference between the transmission time indicated by the transmission time information and the reception time; and
a setting unit operable to set the predetermined time based on the calculated time difference.

3. The network recording system of claim 1,
the terminal device further comprising:
a reception unit operable to receive setting of the predetermined time; and
a setting transmission unit operable to transmit setting information relating to the received setting to the recording device, and
the recording device further comprising:
a setting unit operable to set the predetermined time based on the setting information transmitted from the terminal device.

4. A recording device comprising:
a receiving unit operable to receive recording instruction information for a punctual program via a network from an external device;
a program receiving unit operable to receive the punctual program;
a recording unit operable to start a recording operation of the punctual program from a start time of the punctual program, the recording operation including recording the punctual program and performing a process related to the recording; and
a discontinuing unit operable to cause the recording unit to discontinue the recording operation of the punctual program, if the receiving unit does not receive the recording instruction information before a predetermined time elapses from the start time of the punctual program.

5. The recording device of claim 4, further comprising:
a transmitting unit operable to transmit recording instruction information to another recording device via the network, to instruct the other recording device to record a punctual program.

6. A recording method comprising steps of:
receiving a punctual program;
starting a recording operation of the punctual program from a start time of the punctual program, the recording operation including recording the punctual program and performing a process related to the recording;
receiving recording instruction information for the punctual program via a network from an external device; and
discontinuing the recording operation of the punctual program, if the recording instruction information is not received in the receiving step before a predetermined time elapses from the start time of the punctual program.

7. A computer-readable control program to cause a recording device to perform a recording control, the recording device including a processor, a reception tuner, and a network communication unit, the computer-readable control program comprising steps of:
starting a recording operation of a punctual program that is received by the reception tuner from a start time of the punctual program, the recording operation including recording the punctual program and performing a process related to the recording; and
discontinuing the recording operation of the punctual program, if the network communication unit does not receive recording instruction information for the punctual program, via a network, from an external device before a predetermined time elapses from the start time of the punctual program.

8. A storage medium storing a computer-readable control program to cause a recording device to perform a recording control, the recording device including a processor, a reception tuner, and a network communication unit, the computer-readable control program comprising steps of:
starting a recording operation of a punctual program that is received by the reception tuner from a start time of the punctual program, the recording operation including recording the punctual program and performing a process related to the recording; and
discontinuing the recording operation of the punctual program, if the network communication unit does not receive recording instruction information for the punctual program, via a network, from an external device before a predetermined time elapses from the start time of the punctual program.

9. An integrated circuit for use in a recording device including a receiving unit operable to receive recording instruction information for a punctual program from an external device via a network and a program receiving unit operable to receive the punctual program, the integrated circuit comprising:
a recording unit operable to start a recording operation of the punctual program from a start time of the punctual program, the recording operation including recording the punctual program and performing a process related to the recording; and
a discontinuing unit operable to cause the recording unit to discontinue the recording operation of the punctual program, if the receiving unit does not receive the recording instruction information for the punctual program before a predetermined time elapses from the start time of the punctual program.
